(19) United States
(12) Patent Application Publication
(10) Pub. No.: US 2019/0276297 A1
(43) Pub. Date: Sep. 12, 2019

(54) AUTOMATED BEVERAGE SYSTEM

(71) Applicant: Barsys LLC, New York, NY (US)

(72) Inventor: Akshet Tewari, New Delhi (IN)

(73) Assignee: Barsys LLC, New York, NY (US)

(21) Appl. No.: 16/335,994

(22) PCT Filed: Sep. 22, 2017
(86) PCT No.: PCT/IN17/50420

§ 371 Date: Mar. 22, 2019

(30) Foreign Application Priority Data
Sep. 26, 2016 (IN) 201611032727

(51) Int. Cl. B67D 1/00; B67D 1/04

(52) U.S. Cl. CPC B67D 1/0041; B67D 1/07; B67D 1/0053; B67D 1/0425

(57) ABSTRACT

Automated beverage systems for preparing beverages including one or more beverage ingredients are disclosed. In one embodiment, a beverage system may be arranged to move a beverage cup between a plurality of dispensing stations, and one or more beverage ingredients may be dispensed into the beverage cup at each of the plurality of dispensing stations. The beverage system may include one or more container fittings to attach containers of beverage ingredients to the beverage system. Moreover, the beverage system may include an agitator associated with the beverage cup to mix the beverage ingredients after they are dispensed into the beverage cup at the dispensing stations.

### RELATED APPLICATIONS

This application claims the benefit of priority Indian application number 201611032727 filed Sep. 26, 2016, titled, “Automated Cocktail Maker Machine”, the disclosure of which is incorporated herein by reference in its entirety.

### FIELD

Disclosed embodiments are related to automated systems for preparing beverages.

### BACKGROUND

Mixed drinks, cocktails, or other beverages often include multiple beverage ingredients that are mixed together in specific proportions. For example, a beverage may include specific proportions of one or more alcoholic beverage ingredients such as spirits mixed with specific proportions of one or more non-alcoholic beverage ingredients such as juices or carbonated ingredients (e.g., cola, seltzer, etc.). Accordingly, preparing a beverage may require an individual to carefully measure the various beverage ingredients according to a particular recipe and combine the beverage ingredients to form the beverage.

### SUMMARY

In one embodiment, a container fitting includes a housing and a container fitting located on the housing. The container fitting is constructed and arranged to mount a beverage ingredient container to the housing. The container fitting includes a first channel to permit flow of a gas into the beverage ingredient container and a second channel to permit flow of a beverage ingredient out of the beverage ingredient container.

In another embodiment, a beverage system includes a housing having a dispensing region including a plurality of dispensing stations, a track located in the dispensing region, a carriage movable along the track between the plurality of dispensing stations, and an actuator drivingly coupled to the carriage to move the carriage along the track.

In a further embodiment, a beverage system includes a housing having a dispensing region and a beverage cup receivable in the dispensing region. The beverage cup includes a base including an actuator and a receptacle mounted on the base and including an agitator coupled to the actuator. The actuator is constructed and arranged to move the agitator to mix one or more beverage ingredients received in the receptacle to form a beverage.

In yet another embodiment, a method of operating a beverage system includes moving a beverage cup along a track to a first dispensing station of a beverage system and flowing a gas into a first container containing a first beverage ingredient. The method further includes causing flow of the first beverage ingredient out of the first container, at least in part, due to the flow of the gas into the first container, and dispensing the first beverage ingredient into the cup at the first dispensing station.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a front perspective view of one embodiment of a beverage system;

FIG. 2 is a perspective view of the embodiment of FIG. 1 including a plurality of beverage ingredient containers and a; and

FIG. 3 is a schematic cross-sectional rear view of a beverage system according to one embodiment;

FIG. 4 is a schematic representation of a distribution system according to one embodiment;

FIG. 5 is a perspective view of a container fitting according to one embodiment;

FIG. 6 is a schematic side view of the container fitting of FIG. 5;

FIG. 7 is a perspective top view of a container fitting according one embodiment;

FIG. 8 is a schematic side view of a container fitting and an associated container mounted to the container fitting, according to one embodiment;

FIG. 9 is a perspective view of one embodiment of a container fitting;

FIG. 10 is a side view of the container fitting of FIG. 9;

FIG. 11 is a schematic top view of a track and carriage according to one embodiment;

FIG. 12 is a schematic representation of a beverage cup according to one embodiment;

FIG. 13 is a perspective view of a portion of a base of a beverage cup according to one embodiment;

FIG. 14 is a perspective view of a portion of a beverage system according to one embodiment;

FIG. 15 depicts one embodiment of a user interface for a beverage system;

FIG. 16 depicts another embodiment of a user interface for a beverage system;

FIG. 17 depicts a user interface for customizing a beverage according to one embodiment;

FIG. 18 depicts one embodiment of a user interface for displaying a status of a beverage system according to one embodiment; and

FIG. 19 is a flow chart depicting one embodiment of a method of operating a beverage system.

### DETAILED DESCRIPTION

The inventor has appreciated numerous benefits associated with automated systems for preparing beverages such as mixed drinks and/or cocktails. For example, such systems may automatically dispense one or more beverage ingredients in predetermined quantities or ratios to prepare a desired beverage. In this manner, an automated system may afford simple, fast, and/or more precise preparation of the beverage. In some instances many individuals (e.g., bartenders and/or servers) at a bar, restaurant, or other establishment that serves mixed drinks, cocktails, and/or other beverages may need to undergo substantial training to reliably and quickly prepare a variety of beverages. Such training may involve a considerable amount of time memorizing and practicing numerous beverage recipes. Accordingly, the inventor has appreciated that an automated beverage preparation system may reduce the amount of training required to prepare beverages, as well as the cumulative labor required for preparing the beverages. Moreover, such systems may allow various beverages to be prepared consistently and accurately by multiple users.

The inventor has also recognized that many beverages may include a carbonated beverage ingredient that may lose appeal if the amount of carbonation is diminished (e.g., if the carbonated beverage ingredient goes flat). Moreover, some non-carbonated beverage ingredients (e.g., juices) may be perishable and/or may have a flavor that diminishes over time once a container of the beverage ingredient is opened. In view of the above, the inventors have appreciated benefits associated with automated beverage systems that preserve the carbonation and/or flavors of the various beverage ingredients. For example, in some embodiments an automated beverage system may include a distribution system arranged to distribute beverage ingredients from one or more containers of carbonated and/or non-carbonated beverage ingredients, and the distribution system may be constructed and arranged to seal the containers when the various beverage ingredients are not in use.

In some embodiments, a beverage preparation system may be arranged to mount and/or display one or more containers (e.g., bottles) of alcoholic or other beverage ingredients on an exterior of the beverage system. For example, the containers may be held in an inverted fashion on the exterior of the system, which may aid in dispensing the beverage ingredient from the container (e.g., due to gravity). In some instances, such an inverted arrangement of the containers of the various beverage ingredients also may provide an attractive aesthetic appearance for the beverage system, which may be desirable in some locations where the beverage system is used (e.g., bars, restaurants, clubs, private residences, or other establishments). Moreover, the external mounting/display of the beverage ingredient containers may promote visibility of the beverage ingredients, which may aid in allowing a user or customer to select a desired beverage made from those ingredients. In some embodiments, the beverage system may include one or more lighting elements that may enhance the aesthetics of the beverage system. For example, the lighting element(s) may be configured to illuminate the containers of beverage ingredients with one or more colors of light to provide a desired aesthetic appearance for the system and/or enhance the visibility of the system and the beverage ingredients mounted thereon.

As used herein, a beverage may refer to a mixed drink and/or cocktail, which may include a combination of one or more consumable beverage ingredients. The beverage ingredients may be alcoholic, non-alcoholic, carbonated, non-carbonated, and so on, and in some instances, the beverage ingredients may include suspended and/or dissolved solids or gases. In some embodiments, a beverage may be mixed via mechanical agitation to combine the beverage ingredients. For example, a beverage may be mixed by stirring multiple beverage ingredients to form a homogenous mixture within a beverage cup (or other suitable vessel). Depending on the embodiment, stirring may involve directly agitating the beverage ingredients within the cup (e.g., with a spoon or other suitable utensil) and/or applying a suitable force to the cup, such as by rotating or vibrating the cup. In some embodiments, the dispensing of the beverage ingredients into the cup may be sufficient to mix the beverage ingredients. Moreover, in some embodiments a beverage may be formed without mixing the various beverage ingredients, as the current disclosure is not limited in this regard. Accordingly, it should be understood that a beverage prepared by the automated systems described herein may include a single beverage ingredient, or a homogenous or heterogeneous mixture of two or more beverage ingredients.

According to one aspect of the present disclosure, an automated beverage system may include one or more container fittings that facilitate the attachment or mounting of one or more containers of beverage ingredients to the beverage system. For example, as noted above, the fittings may be arranged to mount the containers (e.g., bottles) in an inverted configuration on the exterior of the beverage system. Alternatively or additionally, a beverage system may include one or more container fittings arranged to mount beverage ingredient containers in a horizontal arrangement (e.g., via sliding the containers into a housing of the system). Moreover, a beverage system may include container fittings located on an external surface of the system (e.g., on a housing) and/or internally within the system. The container fittings may be arranged to couple to the mouth or opening of the containers and create a seal within the opening such that the contents cannot escape around a periphery of the container fitting when the container is inverted or in any other suitable orientation (e.g., upright, angled, etc.).

In some embodiments, container fittings may include one or more channels to permit flow of liquid and/or gas into and out of the containers. For example, the fittings may include a first channel through which gases may flow into or out of the container, and a second channel through which the beverage ingredient can flow into or out of the container. In one embodiment, air (or other suitable gases) may be pumped into the container via the first channel in the container fitting to aid in dispensing the beverage ingredient out of the container through the second channel. For example, such an arrangement may allow the beverage ingredient to be dispensed from the container at faster rate compared to a configuration in which the beverage ingredient is dispensed only via gravity induced flow. In some embodiments, the beverage ingredient may be dispensed via a combination of air (or other gas) pressure and gravity to further enhance the dispensing rate.

Depending on the particular embodiment, the one or more container fittings may be arranged in any suitable fashion such that gases may flow through a first channel and a beverage ingredient may flow through a second channel. Although embodiments described herein include container fittings arranged to mount containers of beverage ingredients in an inverted orientation, it should be understood that other arrangements may be suitable, as the current disclosure is not limited in this regard. For example, the fittings may be arranged to couple to containers in an upright orientation, a horizontal orientation, or at an upwardly or downwardly angled orientation. Moreover, different fittings within a single beverage system may be arranged to mount different containers in different orientations. Accordingly, a beverage system may include container fittings arranged in any suitable manner such that a beverage ingredient can be dispensed from a container via pressurized gas (e.g., air) entering the container and displacing the beverage ingredient contained therein. As noted above, pressurization of the container may allow for a beverage ingredient to be dispensed from the container faster than by gravity flow. In this manner, the pressurization of a beverage ingredient container may reduce the time required to dispense a beverage ingredient and prepare a beverage. Moreover, in some embodiments, the container fittings may be constructed and arranged to seal the beverage ingredient containers under positive pressure (i.e., a pressure greater than an ambient pressure) when the beverage ingredients are not in use. Without wishing to be bound by theory, the positive pressure may aid in maintaining the carbonation and/or flavor of the beverage ingredients, which may allow the beverage ingredients to be better preserved. Moreover, maintaining the carbonation and flavors of the beverage ingredients may reduce or eliminate the need for complex carbonating and/or flavoring systems that may otherwise be required to prepare or maintain the beverage ingredients. However, it should be understood that such systems may be included in certain embodiments of the beverage systems described herein, as the current disclosure is not limited in this regard.

According to some aspects, an automated beverage system may include a distribution system to move the one or more beverage ingredients within the system and dispense the beverage ingredients into a beverage cup or other suitable receptacle. The distribution system may include one or more pumps arranged to cause the one or more beverage ingredients to flow within the beverage system, as well as one or more valves (e.g., solenoid driven valves) associated with the beverage ingredient containers to selectively control the flow of gases and beverage ingredients into and out of the containers. In this manner, the pump(s) and valve(s) may cooperate to dispense a desired amount of a beverage ingredient from the containers. In some embodiments, the pumps may be used to pressurize the containers by pumping air (or other suitable gases) into the containers to cause flow of the beverage ingredient. For example, addition of pressure to a container while a valve associate with the container is open may cause the beverage ingredient flow out of the container and be distributed within the beverage system. When the valve is closed to prevent outflow of the beverage ingredient, the pressurization may seal the beverage ingredient container and may aid in retaining carbonation, flavors, or other desirable characteristics, as discussed previously. In some instances, the pressurization of the containers may allow for dispensing of a beverage ingredient without requiring activation of an associate pump. For example, opening a valve associated with a pressurized container may permit a desired quantity of the beverage ingredient to flow out of the container as some of the pressure is released.

In some embodiments, the use of pressure to cause flow the various beverage ingredients within the beverage system may reduce or eliminate contact between the pump and the beverage ingredients, which may aid in avoiding undesired mixing of the beverage ingredients or cross contamination of beverage ingredient flavors or characteristics. Such an arrangement may allow for easier cleaning of the beverage system, as the pumps may not require cleaning that might be necessary if they contacted the beverage ingredients directly.

In addition to the above, in certain embodiments, a distribution system may further include a cleaning system to rinse and/or clean various components of the distribution system that may contact the beverage ingredients, such as lines through which the beverage ingredients flow. For example, the cleaning system may be arranged to flush a cleaning agent such as water or a suitable cleaning solution through the lines of the distribution system. In some embodiments, the cleaning system may use one or more components of the distribution system, such as one or more pumps, to cause the cleaning agent to flow through the distribution system. For example, similar to the distribution of the beverage ingredients discussed above, the cleaning system may utilize pressurized air (or other gases) to cause flow of the cleaning agent through the distribution system.

According to one aspect of the present disclosure, an automated beverage system may include one or more dispensing stations at which the one or more beverage ingredients are dispensed into to a beverage cup or other vessel to prepare a desired beverage. In some embodiments, the system may have at least a first station configured to dispense alcoholic beverage ingredients and a second station configured to dispense non-alcoholic beverage ingredients. Such an arrangement may reduce or eliminate cross contamination between alcoholic and non-alcoholic ingredients. In some embodiments, the first and second stations may be include one or more nozzles connected by a line to an associated beverage ingredient container, and the nozzles may dispense the beverage ingredients into the beverage cup. For example, the stations may be positioned above the beverage cup and the nozzles may direct the beverage ingredients to flow down into the cup.

In some embodiments, an automated beverage system may include a beverage cup arranged to receive the various beverage ingredients that comprise a desired beverage. For example, the beverage cup may configured as a removable receptacle placed below a dispensing station and arranged to receive beverage ingredients as they are dispensed from the nozzles. In some instances, the beverage cup may be a vessel (such as a glass) in which the beverage is intended to be served, and the beverage cup may be removed from the beverage system and to allow the beverage to be consumed directly from the beverage cup once the beverage is prepared. In some embodiments, such an arrangement may permit the use of multiple beverage cups such that multiple beverages may be made in sequence without requiring cleaning of the cup(s) before preparing subsequent beverages. In this manner, the use of multiple beverage cups may allow the automated beverage system to be operated in a sanitary way by reducing or preventing the possibility of cross-contamination between the beverage cups.

In some embodiments, the beverage system may include an agitator constructed and arranged to aid in mixing the beverage ingredients once they are dispensed into the beverage cup. For example, the agitator may be provided in the beverage cup, and may include a features such as paddles and/or blades that spin within the beverage cup to mix and combine the beverage ingredients. The spinning motion may be powered by a motor or other suitable actuator coupled to the agitator. In some embodiments, the motor may be powered wirelessly via a wireless power transmission system located on the beverage system, such as on a carriage arranged to hold the beverage cup. In one embodiment, a controller on the beverage system may cause a current to pass through a wireless power coil, which in turn may induce a current in a corresponding coil and motor associated with the agitator to spin the agitator within the beverage cup. Although agitators arranged to spin within a beverage cup are described herein, it should be understood that other agitator structures and/or methods to mix beverage ingredients, such as shaking or stirring, also may be suitable, as the current disclosure is not limited to spinning agitators.

In some embodiments, the agitator may include one or more components located in the beverage cup that are magnetically coupled to corresponding features on the carriage of the beverage system. For example, the agitator may include a blending component located in the beverage cup that includes magnet configured to rotate about an axis. The carriage may include a second rotatable magnet that is magnetically coupled to the magnet in the blending component such that rotational movement of the second magnet in the carriage causes the blender component to spin within the beverage cup to agitate and mix the beverage ingredients.

According to some aspects of the present disclosure, an automated beverage system may include a carriage actuator arranged to translate the carriage that holds the beverage cup(s) along a track to move the beverage cups between one or more dispensing stations where different beverage ingredients may be dispensed into the beverage cups. For example, the actuator may include a motor, servo, linear actuator, electromagnet, or other suitable device, and the actuator may be coupled to the carriage to move the carriage along a track. Depending on the particular embodiment, the actuator may be directly coupled to the carriage, or it may be coupled to the carriage via a rack and pinion, ball screw, belt drive, or any other suitable structure such that the actuator may move the carriage (and an beverage cup located thereon) between the dispensing stations of the beverage system.

In some embodiments, an automated beverage system may include a controller configured to control one or more aspects of the preparation of a beverage. For example, the controller may be associated with the pumps, valves, agitator(s), carriage actuator, and/or other components of the beverage system and may control these components to automatically prepare a desired beverage. For example, the controller may selectively activate the pumps, valves, agitator, and carriage actuator to dispense specific quantities of beverage ingredients into a beverage cup and mix the ingredients according to a desired beverage recipe.

A beverage system may also include a user interface to allow a user to select a desired beverage. For example, the user interface may be associated with the controller, and the controller may receive a request for a desired beverage from the user input and operate the beverage system to prepare the beverage automatically. Depending on the particular embodiment, the user interface may be provided on the beverage system and/or on an external device. In some embodiments, the user interface may include a mobile application on a device such as a tablet or smartphone, and the application may include a menu from which an user can request a desired beverage. The mobile application may be arranged to communicate with the beverage system, allowing the user interface to display notifications or other indications of the progress for the beverage preparation process. For example, the user may receive a notification on the device when the beverage preparation is completed.

In certain embodiments, the user interface may be configured to monitor and/or manage inventory of the beverage ingredients in the beverage system. Such an inventory management system may allow for tracking of the usage of the different beverage ingredients, and may notify a user is a container of a beverage ingredient is in need of replacement.

In some embodiments, the user interface may permit customization of a desired beverage. For example, an user may select a customized quantity of one or more beverage ingredients comprising a particular beverage. In this manner, individual users may specify the quantities and/or ratios of beverage ingredients if desired In some embodiments, the user interface may allow an individual user to save a custom beverage recipe to allow for simple reordering of the customized beverage.

As noted previously, an automated beverage system may include a distribution system including a cleaning system for cleaning lines used to distribute the various beverage ingredients. In some such embodiments, the user interface may include an option to run an automated cleaning process that activates the cleaning system and flushes the distribution lines with mineral water (or other suitable cleaning agents). In some other embodiments, the beverage system may be arranged to automatically run a cleaning cycle after a predefined period of time or after a predefined number of beverages have been prepared by the beverage system. In some instances, such arrangements may allow the beverage system to more easily meet certain standards for food safety without requiring substantial additional labor to clean the system.

Turning now to the figures, specific non-limiting embodiments of an automated beverage preparation system are described in further detail. While specific embodiments are described, it should be understood that the various components, systems, and methods of operation described herein may be combined in any suitable fashion as the current disclosure is not so limited.

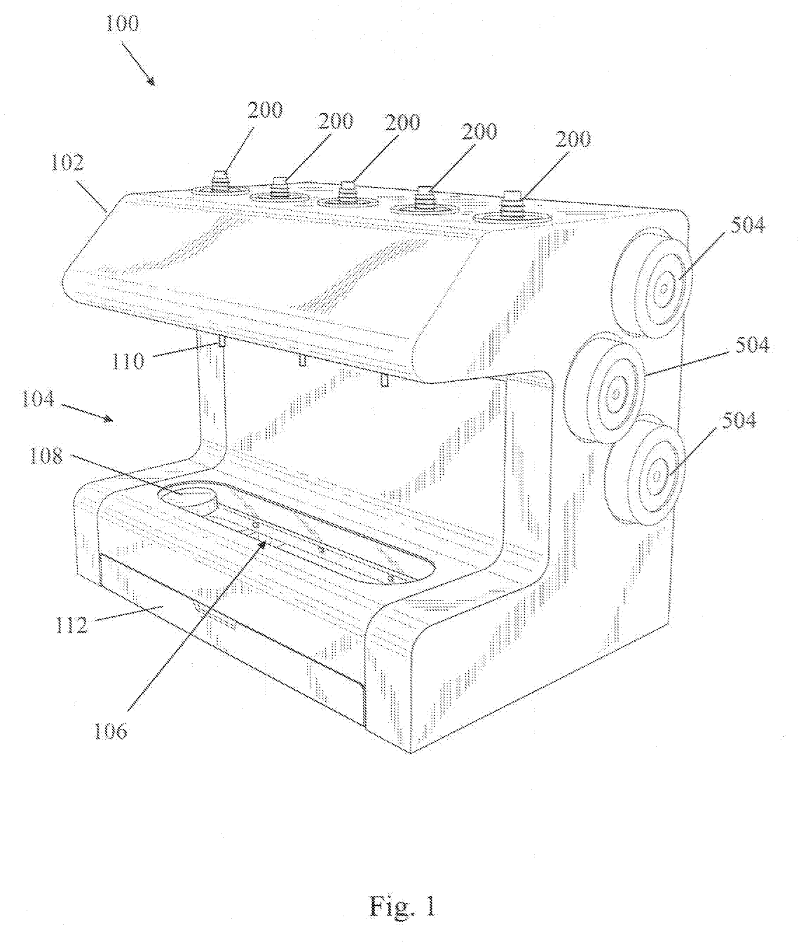

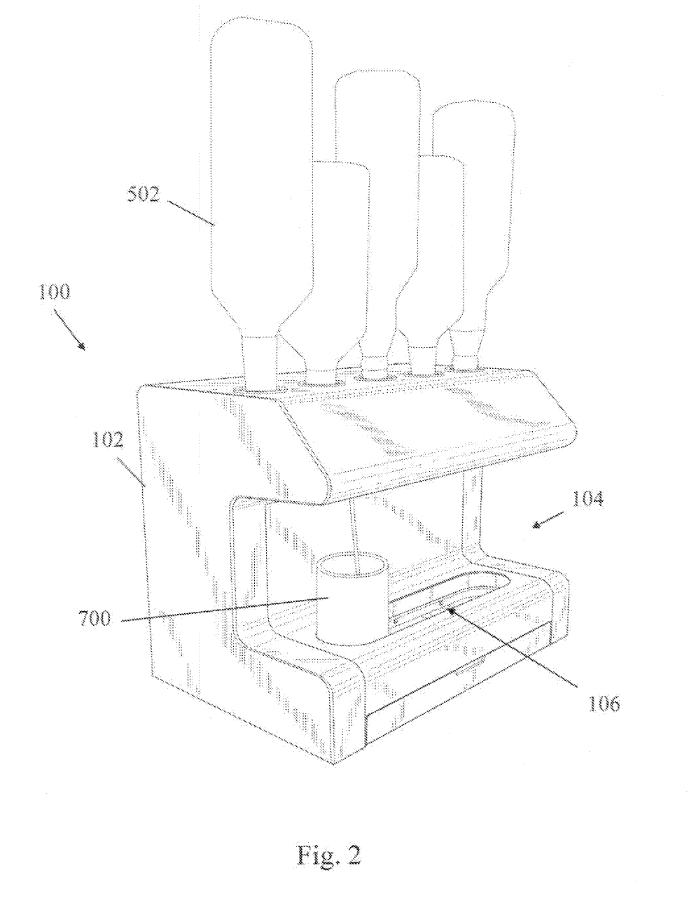

FIGS. 1-2 depicts one embodiment of an automated beverage system 100. The system includes a housing 102, and as described in more detail below, the housing may contain various components of the system, such as a distribution system including one or more valves and pumps, one or more motors or other drive elements, and/or a control system that controls various aspects of the operation of the beverage system. The system 100 includes a dispensing region 104 arranged to receive a beverage cup 700 (or other suitable vessel or receptacle) such that one or more beverage ingredients may be dispensed form the beverage system into the cup (see FIG. 2). Moreover, a track 106 including a carriage 108 constructed and arranged to receive the beverage cup is located within the dispensing region 104. As described in more detail below, the carriage 108 may be movable within the dispensing region along the track 106 to move the beverage receptacle within the dispensing region.

In some embodiments, a dispensing region may include one or more dispensing stations at which one or more different beverage ingredients may be dispensed into a beverage cup. For example, the dispensing stations may correspond to locations within the dispensing region where the beverage cup is aligned with an outlet 110 from which one or more particular beverage ingredients are dispensed. In some embodiments, the dispensing stations may correspond to locations directly beneath the outlets 110, though other arrangements may be suitable. For example, in certain embodiments, a beverage ingredient may flow out of an outlet 110 at an angle, and the dispensing stations may correspond to locations for the beverage cup where the beverage ingredient may flow directly into the cup.

Moreover, it should be understood that the current disclosure is not limited to any particular number of dispensing stations. For example, in the embodiment depicted in FIG. 1, the beverage system 100 includes three outlets 110, and correspondingly, the dispensing region 104 includes three dispensing stations, with one dispensing station between each outlet. In other embodiments, a beverage system may have fewer than three outlets and dispensing stations (e.g., one or two) or more than three outlets.

In some embodiments, one or more outlets 110 of a beverage system 100 (and corresponding dispensing stations) may be arranged to dispense a particular type of beverage ingredient. For example, a beverage system including two dispensing stations may include a first dispensing station to dispense alcoholic beverage ingredients and a second dispensing station to dispense non-alcoholic beverage ingredients. In another embodiment, a beverage system including three dispensing stations may have a first dispensing station to dispense alcoholic beverage ingredients, a second beverage station to dispense non-alcoholic and non-carbonated beverage ingredients, and a third dispensing station to dispense non-alcoholic carbonated beverage ingredients. In other embodiments, a beverage system may have a separate outlet and corresponding dispensing station for each of the beverage ingredients that may be dispensed from the beverage system. Accordingly, the current disclosure is not limited to any particular arrangement of dispensing stations in the dispensing region.

As noted above, a beverage system 100 may include a track 106 in the dispensing region, and the a carriage 108 located in the track and constructed and arranged to receive a beverage cup 700 (see FIG. 2). As described in more detail below, the carriage may be coupled to an actuator, such as a motor, to drive movement of the carriage along the track and move the beverage cup between the various dispensing stations where one or more beverage ingredients may be dispensed into the beverage cup. While FIGS. 1-2 depict an embodiment in which the track 106 is formed as a recessed channel in the dispensing region 104, other arrangements are also contemplated. For example, the track 106 and/or carriage 108 may be flush with the housing 102 in the dispensing region, or may protrude from the housing. Moreover, while a linear track is depicted in the figures, other arrangements such as tracks with multiple linear and or curved segments may be suitable, as the current disclosure is not limited in this regard.

In addition to the above, it should be understood that the carriage 108 may have any suitable configuration such that a beverage cup 700 may be received on the carriage and moved between one or more dispensing stations. For example, as illustrated in FIG. 1, the carriage 108 may be a platform (e.g., a circular platform) on which a beverage container may be placed. In other embodiments, a carriage may include a receptacle sized and shaped to receive a portion of a beverage cup. Moreover, as described below, in some embodiments, the carriage may include one or more features arranged to drive a mixing or agitating system within the beverage cup to aid in mixing the beverage ingredients after they are dispensed into the beverage cup.

As illustrated in FIG. 1, the beverage system 100 further includes container fittings 200 located on a top surface of the housing 102. As described in more detail below, the container fittings may be constructed and arranged to mount containers of beverage ingredients to the beverage system. For example FIG. 2 depicts the system 100 with beverage ingredient containers 502 (e.g., bottles) mounted on the system via the container fittings 200. As illustrated, the container fittings may be arranged to mount the containers in an inverted configuration on the housing, which may be desirable to provide a desired aesthetic appearance for the beverage system and/or may assist in dispensing a beverage ingredient from the container, e.g., due to gravity-induced flow. In some embodiments, container fittings 200 located on the top surface of the housing 102 may be arranged for mounting containers of alcoholic beverage ingredients to the beverage system, though other arrangements also may be suitable. While one embodiment including five container fittings 200 is shown in FIG. 1 (and correspondingly, five containers 502 mounted on the system in FIG. 2), it should be understood that a beverage system may include any suitable number of container fittings, as the current disclosure is not limited in this regard.

In addition the containers 502 mounted to the top surface of the housing 102, the beverage system 100 may further include one or more secondary beverage containers 504 that may be inserted into a side of the housing 102. For example the secondary beverage containers may be containers of non-alcoholic beverage ingredients such as juices, and these containers may couple to the beverage system via container fittings located within the housing. Similar to the container fittings 200 and bottles 502 discussed above, a beverage system may include any suitable number of secondary beverage ingredient containers 504 and corresponding container fittings.

In some embodiments, a housing 102 may include a removal portion, such as a removable tray 112. For example, the tray may be associated with a drain located within the track 106, and any beverage ingredients that may inadvertently spill during preparation of a beverage may be directed to the removable tray 112 via the drain. In this manner, such spilled beverage ingredients may be easily cleaned and removed from the system by removing and cleaning the tray 112.

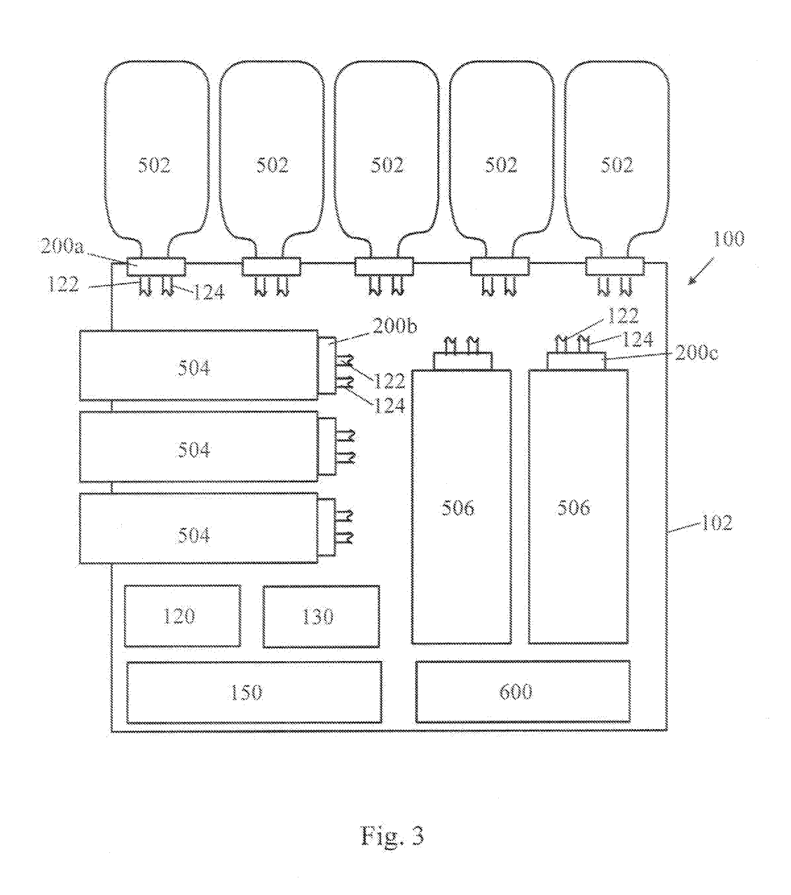

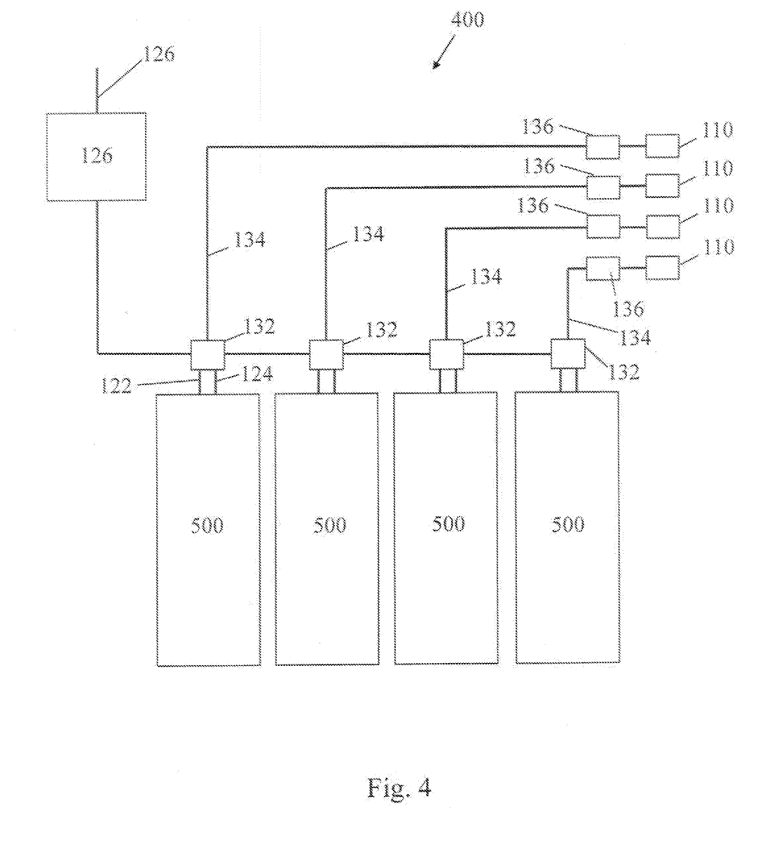

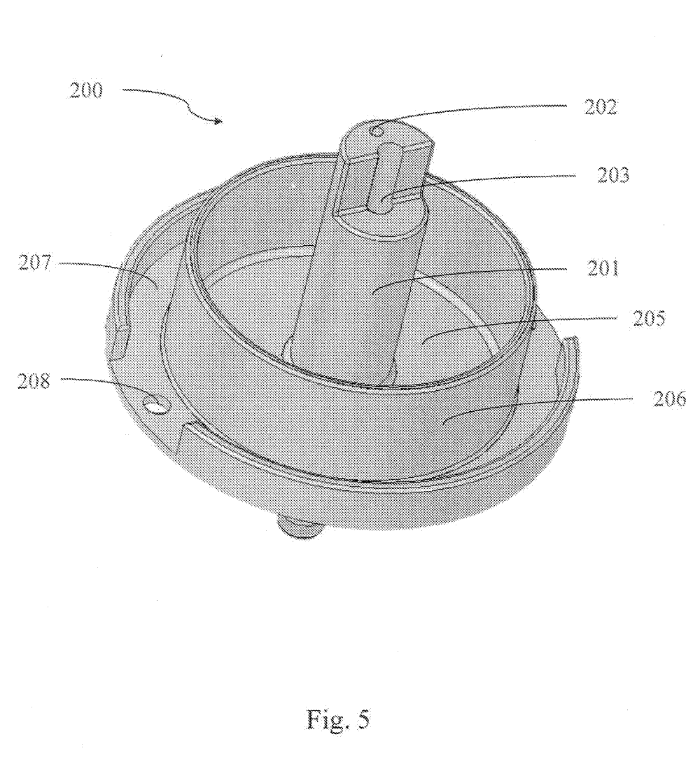

FIG. 3 depicts a schematic rear cross-sectional view of one embodiment of a beverage system 100, similar to the beverage system described above in connection with FIGS. 1-2. In particular, FIG. 3 depicts an embodiment in which three types of beverage ingredient containers are attached to the beverage system 100: first containers 502 (e.g., bottles containing alcoholic beverage ingredients) are mounted in an inverted configuration to an exterior surface of the beverage system housing 102 via container fittings 200a; second containers 504 (e.g., bottles or other suitable vessels containing non-carbonated non-alcoholic beverage ingredients such as juices) are received within a side of the housing 102 and are coupled to the beverage system via container fittings 200b; and third containers 506 (e.g., bottles or other suitable vessels containing carbonated non-alcoholic ingredients) are located within the interior of the housing 102 and are coupled to the system via container fittings 200c. As illustrated, each of the container fittings 200a, 200b, and 200c are coupled to an outlet 122 through which the respective beverage ingredients may flow to be dispensed into a beverage cup, and an inlet 124 to permit flow of air (or other suitable gases) into the beverage containers.

As described in more detail below, the beverage system 100 includes a pump system 120 including one or more pumps and a valve system 130 including one or more valves, and the pump and valve systems may be coupled to a controller 150 that controls operation of the pump system 120 and valve system 130 to selectively control the flow of the beverage ingredients and/or air out of and/or into the beverage containers 502, 504, and 506. Moreover, in some embodiments, a cleaning system 600 may be included. For example, the cleaning system may be associated with the pumping system 120, valve system 130, and controller 150 such that a cleaning solution (e.g., water) may be pumped through the beverage system as needed.

While three types of beverage ingredient containers are depicted in FIG. 3, it should be understood that the current disclosure is not limited to systems including three different types of beverage ingredient containers. For example, as illustrated in FIG. 2, the beverage containers 502 may have different sizes and/or shapes. Moreover, in some embodiments, the same types of beverage containers may be used for different types of beverage ingredients. For instance, a beverage system may use the same type of beverage containers for all of the non-alcoholic beverage ingredients (i.e., carbonated and non-carbonated). In other embodiments, the third beverage containers 506 may be specifically designed to accommodate higher pressure conditions required to contain carbonated beverage ingredients.

Depending on the particular embodiment, the container fittings 200a, 200b, and 200c may have different configurations for different types of beverage ingredient containers. For example, the container fittings 200a may be specifically configured for mounting bottles of alcoholic beverage ingredients in an inverted configuration on the exterior of the beverage system, while the container fittings 200c may be configured to withstand higher pressures for use with carbonated beverage ingredients. However, in other embodiments, a beverage system may utilize the same container fitting arrangement for different types of beverage containers, as the current disclosure is not limited to any particular number or types of container fittings included on a beverage system.

FIG. 4 depicts one embodiment of a distribution system 400 arranged to dispense beverage ingredients from the beverage ingredient containers 500 into a beverage cup (such as cup 700 shown in FIG. 2). In the depicted embodiment, the distribution system includes a pump 126 coupled to valves 132 associated with each beverage ingredient container 500. The valves may selectively permit the flow of beverage ingredients out of the containers via an outlet 122 and flow of air or other suitable gases into the containers via an inlet 124. For example, In the embodiment shown in FIG. 4, the pump 122 is arranged to pump air (or other suitable gases) from an inlet 126 to the valves 132, and the valves may selectively permit flow of air into the beverage ingredient containers 500. Without wishing to be bound by theory, the flow of air into the containers may increase the pressure in the containers, and when the valves are open to permit flow of the beverage ingredients out of the beverage containers via outlets 122, the increase in pressure may cause the beverage ingredient to flow out of the beverage container 500, through the valve 132, and into a distribution line 134 (e.g., a hose, pipe, tube, etc.). In this manner, the pump 126 and valves 132 may cooperate to control the flow of beverage ingredients within the beverage system and dispense the beverage ingredients from one or more outlets 110 coupled to the distribution lines 110.

In some embodiments, such as in the embodiment depicted in FIG. 4, a distribution system 400 may include a separate outlet 110 for each beverage ingredient. Each of these outlets may correspond to a separate dispensing station, as discussed above. In other embodiments, one or more of the distribution lines 134 may be joined before reaching an outlet such that multiple different beverage ingredients may be dispensed from a single outlet 110. For instance, in one embodiment, all of the distribution lines 134 associated with containers of alcoholic beverage ingredients may be joined and arranged to dispense from a single outlet 110, such that all of the alcoholic beverage ingredients may be dispensed at a single dispensing station. Similarly, the distribution lines 134 associated with non-alcoholic beverage ingredients (e.g., carbonated and/or non-carbonated ingredients) may be arranged to dispense those ingredients from a single outlet or from a pair of outlets.

While FIG. 4 depicts an embodiment in which a single pump 126 is arranged to pump air into all of the associated beverage ingredient containers, other arrangements are also contemplated. For example, in some embodiments, each beverage container may have an associated pump that may be operable independently from the pumps attached to other beverage containers. In other embodiments, a distribution system may include a separate pump for each type of beverage ingredient (e.g., alcoholic, non-alcoholic, carbonated, non-carbonated, etc.). Accordingly, the current disclosure is not limited to any particular number and/or arrangement of pumps to distribute beverage ingredients within a beverage system.

Depending on the embodiment, the distribution system 400 may include any suitable types of pumps and/or valves. In one exemplary embodiment, the pump 126 is a diaphragm pump, and the valves 132 are solenoid valves. Moreover, the pumps and/or valves may be arranged to provide a desired flow rate when dispensing the beverage ingredients at a dispensing station. For example, the flow rate may be greater than about 20 ml/sec, greater than about 30 ml/sec, or more. In some instances, the distribution system may be arranged to dispense a beverage ingredient at a flow rate that is faster than what may be achieved by gravity-induced flow along (e.g., due to flow out of an inverted container).

In addition to the above, the distribution system may include one or more flow sensors 136 associated with the distribution lines 134. For example, the flow sensors may be arranged to measure a volume of liquid flowing from a beverage container through a distribution line 134 and to an associated outlet 110, and the volume measured by the flow sensor may be used by an associated controller to determine how much of a particular beverage ingredient has been dispensed. The controller may control the pump 126 and/or valves 132 based on the volume measured by the flow sensor to dispense a desired quantity of a particular beverage ingredient. In some embodiments, the flow sensors may include Hall Effect sensors, optical encoders, or any other suitable type of sensor to measure flow of a fluid beverage ingredient. Alternatively or additionally, a beverage system may include one or more load sensors located in a dispensing region of the beverage system, and the load sensors may be arranged to measure the weight of a beverage cup as beverage ingredients are dispensed into the beverage cup to determine an amount of beverage ingredient dispensed.

As noted previously, in some embodiments, a cleaning system (such as cleaning system 600 shown in FIG. 3) may be associated with one or more components of the distribution system 400. For example, the pump 126 may be associated with a container of a cleaning solution (not depicted), and the pump may be arranged to pump the cleaning solution through the various distribution lines 134 to rinse and/or clean the system. In other embodiments, a cleaning system may have a separate pump arranged to pump the cleaning solution through the system. Moreover, in some embodiments, the valves 132 may be configured as one-way valves such that fluid (i.e., beverage ingredients) is only permitted to flow out of the beverage ingredient containers 500 when the valves are open. Such an arrangement may be desirable to avoid flow of a cleaning solution from the cleaning system into the beverage containers 500.

In addition to the above, while four beverage ingredient containers 500 and four associated valves are shown in FIG. 4, it should be understood that the distribution system may be arranged to dispense beverage ingredients from any suitable number of containers. Moreover, the distribution system may dispense beverage ingredients from different types of beverage ingredient containers (such as containers 502, 504, and 506 discussed above in connection with FIG. 3).

Referring now to FIGS. 5-10, several possible embodiments of container fittings to attach and/or mount beverage ingredient containers to a beverage system are described in more detail.

FIG. 5 shows a perspective view of one embodiment of a container fitting 200. In this embodiment, the container fitting includes a support 201 extending upwardly from a bottom plate 205. A first channel 202 and a second channel 203 are formed through the support, with the first channel configured to permit flow of gas through the container fitting and the second channel 203 configured to permit flow of a beverage ingredient through the container fitting. For example, the first channel 202 may permit flow of air (or other suitable gases) into a beverage ingredient container mounted to a beverage system via the container fitting 200, while the second channel may permit flow of the beverage ingredient out of the container. As discussed previously, flowing air (or other gases) into a container may pressurize the container (i.e., raise the pressure within the container to a pressure higher than an ambient pressure) to cause a beverage ingredient contained therein to flow out of the beverage ingredient container via the second channel 203.

In some embodiments, it may be desirable to arrange the first and second channels 202 and 203 of a container fitting 200 such that they terminate within a container at a different heights. For example, as shown in FIG. 5, the first channel 202 has an opening spaced from (and higher than) an opening of the second channel 203. Without wishing to be bound by theory, such a configuration may aid in avoiding disturbance of the outflow of a beverage ingredient through the second channel by the inflow of air through the first channel. Accordingly, the first channel may be placed at a position such that the air entering the container does not disrupt the regular flow of beverage ingredient out of the second channel.

In some embodiments, a container fitting may include one or more features to mount and/or support a container on a beverage system. For example, in the embodiment depicted in FIG. 5, the container fitting 200 includes a support 201 extending from a central portion of a base plate 205, and a peripheral support 206 extending around a periphery of the base plate. Accordingly, the support 201 may be received by an opening of a beverage ingredient container such that the walls of the container are received in the annular space between the support 201 and the peripheral support 206. As noted previously, in some instances, it may be desirable to attach an inverted container to the container fitting, and correspondingly, the weight of the container and the beverage ingredient contained therein may be supported by the container fitting. Accordingly, the base plate 205 may be arranged to support the weight of the container and beverage ingredient, and the support 201 and peripheral support 206 may be arranged to stabilize the container in the inverted configuration. Moreover, in the depicted embodiment, the container fitting includes a mounting portion 207 with one or more mounting holes 208 for mounting the container fitting to an associated beverage system, such as to an exterior surface of a housing and/or at a location on an interior of the beverage system. Depending on the particular embodiment a container fitting may engage a container via any suitable interface, including, but not limited to, a friction fit interface, a threaded screw interface, and a clamping arrangement.

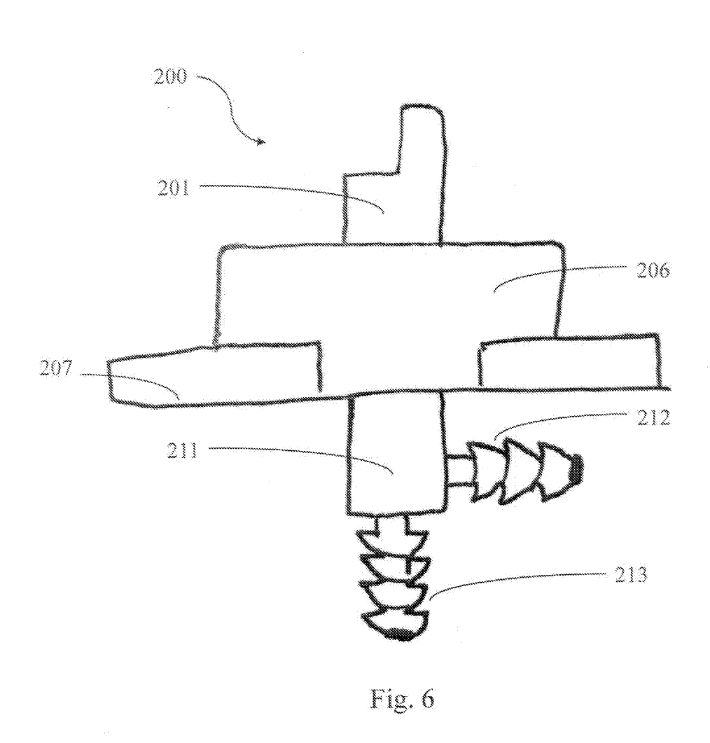

FIG. 6 shows a schematic side view of the container fitting 200 of FIG. 5. As illustrated, the support 201 may include a bottom portion 211 extending below the mounting portion 207. A first connector 212 and a second connector 213 may extend from the bottom portion 211, with the first connector 212 coupled to the first channel 202 and the second connector 213 coupled to the second channel 213. For example, air may flow into the first connector 212 and through the first channel 202 to flow into an attached container, while a beverage ingredient may flow through the second channel 203 and out of the fitting 200 through the second connector 213. In some embodiments, the first connector 212 and second connector 213 of the container fitting 200 may form an L-shape, which, may allow for more facile attachment of the first and second connectors to an associated distribution system. For example, such an arrangement may allow for the connections to the first and second channels to be more easily distinguished when assembling the beverage system. However, it should be understood that other arrangements also may be suitable, including arrangements in which both the first and second connectors extend from the bottom of the bottom portion 211, or arrangements in which the first and second connectors extend from a side of the bottom portion (e.g., perpendicular to the bottom portion and/or at a suitable angle relative to a longitudinal axis of the bottom portion).

Moreover, in some embodiments the first and second connectors may include features to facilitate attachment of a distribution line (e.g., a pipe, tubing, hose, etc.) to the first and second connectors. For example, in the embodiment shown in FIG. 6, each of the first and second connectors includes a plurality of flanges arranged to engage an interior surface of a distribution line. However, it should be understood that other arrangements to secure a distribution line to the container fitting, including, but not limited to, one or more hose clamps, threaded fittings, and adhesives, may be suitable.

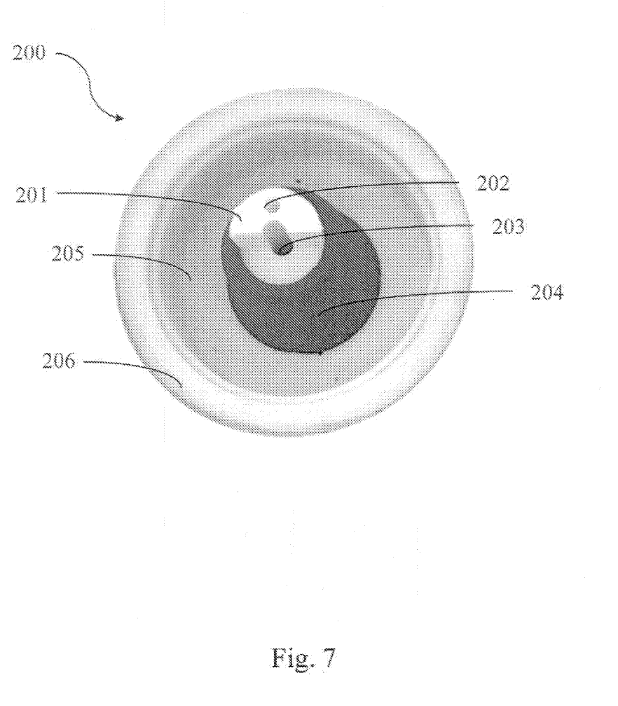

FIG. 7 shows a top perspective view of a portion of a container fitting 200 according to one embodiment. Similar to the embodiment discussed above in connection with FIGS. 5-6, the container fitting 200 depicted in FIG. 6 includes a support 201 extending from a base plate 205 and including a first channel 202 and a second channel 203. In this embodiment, a flexible seal 204 is provided around a portion of the support 201. For example the flexible seal may be constructed and arranged to engage an interior surface of an attached beverage ingredient container and form a fluid tight and/or air tight seal. In some instances, the seal 204 may cooperate with the base plate 205, support 201, and/or peripheral support 206 to aid in supporting an attached container. For example, the seal 204 may be made from rubber or any other suitable deformable material and the seal may include one or more flanges (discussed below) to aid in sealing the a space around the support 201.

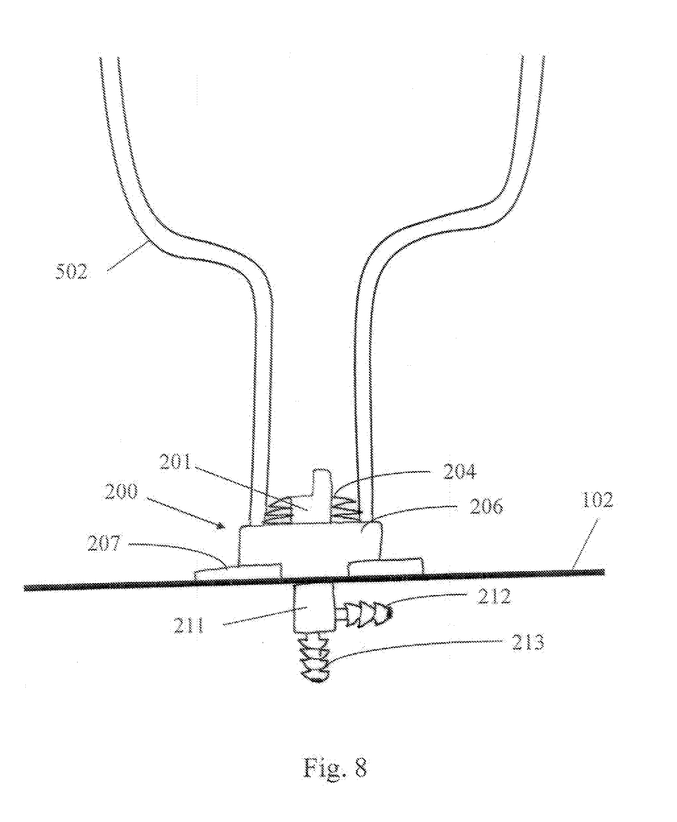

FIG. 8 is a schematic side view of one embodiment of a container fitting 200 installed on a housing 102 of a beverage system. In the depicted embodiment, a beverage container 502 is mounted to the container fitting 200 in an inverted configuration, and the container is sealed along an inner surface of the opening of the container with a seal 204 provided on the support 201. As discussed previously, the seal may include one or more rubber flanges that engage an interior surface of the container. Moreover, the container is supported in the inverted configuration by the support 201, peripheral support 206, and base plate (not depicted).

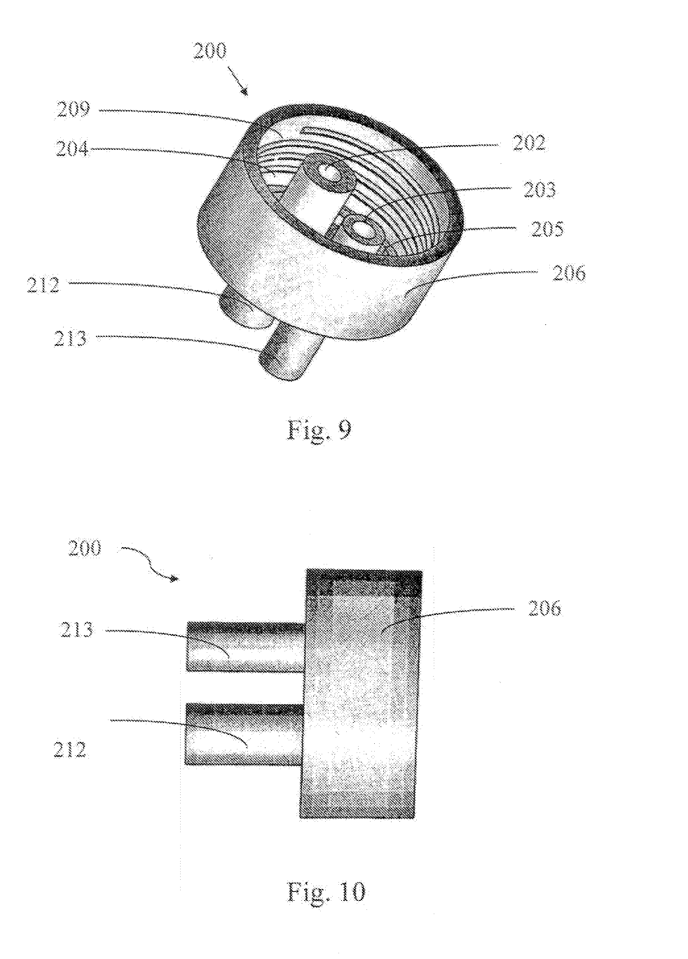

Referring now to FIGS. 9-10, another embodiment of a container fitting 200 is described. In particular, FIGS. 9 and 10 depict a perspective view and a side view of the container fitting 200, respectively. In the depicted embodiment, the container fitting 200 includes a first channel 202 coupled to a first connector 212, and a second channel 203 coupled to a second connector 213. The container fitting further includes a base plate 205 and a peripheral support 206. The peripheral support includes a seal 204, which may be constructed and arranged to form a fluid and air tight seal along an exterior surface of a container attached to the container fitting. As illustrated, the peripheral support 206 includes a threaded portion 209 configured to threadably engage a corresponding threaded portion which may be formed around an opening of the container. Similar to the embodiments described above, the first and second connectors 212 and 213 may be arranged to attach to a distribution line such as a hose, a pipe, tubing, and so on, through which a beverage ingredient or air (or other gases) may flow. In particular, the first connector may be arranged to permit the inflow of air (or other gases) into an attached container, while the second channel may be arranged to permit outflow of a beverage ingredient from the container.

In some embodiments, a portion of a container fitting, such as a portion of a mounting portion 207 (see FIG. 5) may be further configured to mount one or more lighting elements to the container fitting. For example, the mounting portion 207 may be arranged to mount LED rings along the upper surface of the container fitting, and the LED rings may be arranged to illuminate the attached container. For instance, the LED ring may project light in the direction of the container, such that logos, brands, or other features of the container may be observed and/or to provide a desired aesthetic appearance. In certain embodiments, the one or more lighting elements may be reactive, such that they change in color or brightness in response to one or more stimuli (e.g. music, ambient light level, time of day, etc.). Accordingly, the lighting elements may have one or more addressable elements, such that brightness or color changes may be controlled by selectively controlling the various addressable elements. While LED based lighting elements (such as LED rings) are described herein, it should be understood that any suitable lighting element may be employed, such as neon lights and/or incandescent lights, as the current disclosure is not limited in this regard.

Depending on the embodiment, a container fitting may be formed from any suitable material, which may include food grade materials. For example, the container fitting may be made of plastic, metal, ceramic, or other material suitable for use with consumable beverage ingredients. In one embodiment, the container fitting is made of an high-density polyethylene (HDPE) or low-density polyethylene (LDPE) material. Moreover, the channels within a container fitting may be arranged with any suitable diameter such that air and/or liquid beverage ingredients can flow into or out of a corresponding container, respectively, without obstruction. For example, in one embodiment, the first channel may have a diameter of about 1-4 mm (e.g., about 2.5 mm) and the second channel may have a diameter of about 2-6 mm (e.g., about 4 mm). In one such embodiment, a support through which the channels are formed may a diameter of about 10-15 mm (e.g., about 13 mm). However, it should be understood that other dimensions for the channels and/or post also may be suitable.

Moreover, as noted previously, a container fitting may be arranged to maintain a positive pressure (i.e., a pressure greater than an ambient pressure) within a container of a beverage ingredient when that beverage ingredient is not in use. For example, by maintaining a positive pressure within the container, properties of the beverage ingredient contained therein (such as flavors and/or carbonation) may be better preserved. Accordingly, in some embodiments, the container fitting may be constructed and arranged to withstand a desired positive pressure within a beverage container when the container is attached to a beverage system via the container fitting.

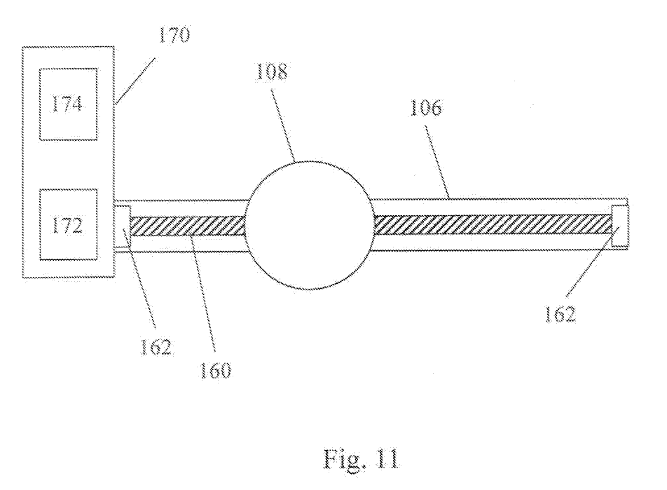

Referring now to FIG. 11, aspects of a track and associated carriage to move a beverage cup between one or more dispensing stations is described in more detail. In particular, FIG. 10 is a schematic top view of one embodiment of a track 106 on which a carriage 108 may be moved to move an associated beverage cup between one or more dispensing stations, where one or more different beverage ingredients may be dispensed into the beverage cup. As illustrated, the carriage 108 is coupled to a belt 160 that is driven by an associated actuator 172 to move the carriage along the track 106, and a controller 172 may be coupled to the actuator to control the movement of the carriage. In the depicted embodiment, and controller may be received in a housing 170, which may be located within a housing 102 of a beverage system. Moreover, in some embodiments, one or more sensors 162 may be arranged to detect a position of the carriage 108 along the track 106. For example, the sensors may be limit switches located at the ends of the track 106, and contact between the carriage 108 and the limit switches may cause a signal to be sent to the controller 174 indicating the position of the carriages. In other embodiments, one or more additional sensors such as optical sensors and/or proximity sensors may be provided along the length of the track to detect the position of the carriage. For example, the one or more sensors may detect when the carriage arrives at and/or leaves a dispensing station.

In some embodiments, the actuator 172 may include stepper motor. According to some aspects, a stepper motor may allow the controller 174 to control the position of the carriage without requiring additional sensors along the length of the track to sense the position of the carriage. For example, each step of the stepper motor may be counted by the controller and may be correlated to a distance along the track 106. In this manner, the controller 174 and stepper motor may move the carriage 108 between one or more dispensing stations by operating the stepper motor for a prescribed number of steps corresponding to a distance between dispensing stations. As noted above, sensors 162 (such as limit switches) may be located at the ends of the track, and such sensors may be used in conjunction with a stepper motor to recalibrate the position of the carriage in the case of any drift in the calculated position of the carriage.

In certain embodiments, a controller 174 and actuator 172 may cooperate to move a carriage 108 along a track 106 according to a desired movement profile, which may include various accelerations and/or velocities of the carriage. In some embodiments, a movement profile that avoids stop and go or jerky motion of the carriage (and associated beverage cup) may be desirable to avoid spilling of beverage ingredients from the beverage cup. Accordingly, the controller and actuator may cause the carriage to smoothly accelerate as it is moved away from a dispensing station and decelerate as it arrives at a subsequent dispensing station. In some embodiments, the movement profile may include one or more intermediate portions corresponding to movement between dispensing stations, and the carriage may move at a constant velocity during these intermediate portions. However, it should be understood that other movement profiles may be suitable, as this current disclosure is not limited to any particular combination of accelerations and/or velocities as a carriage is moved along a track.

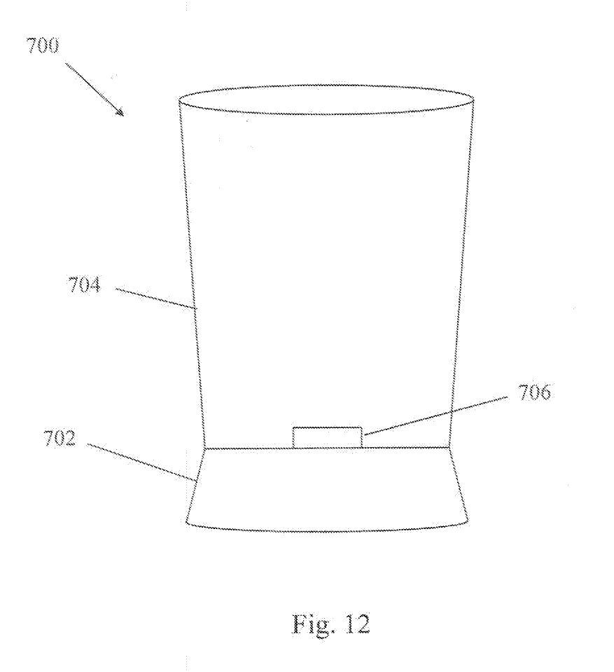

As discussed previously, in some embodiments, a beverage system may include a beverage cup including an agitator arranged to mix one or more beverage ingredients together after they are received in the beverage cup. For example, FIG. 12 depicts one embodiment of a beverage cup 700 including a base 702 and a receptacle 704 mounted on the base. As discussed below, the base may include one or more features such as an actuator and a power source to drive movement of an agitator 706 located in the receptacle. Movement of the agitator (e.g., rotational, vibrational or other types of movement) may mix the various beverage ingredients received in the receptacle to form a homogenous mixture.

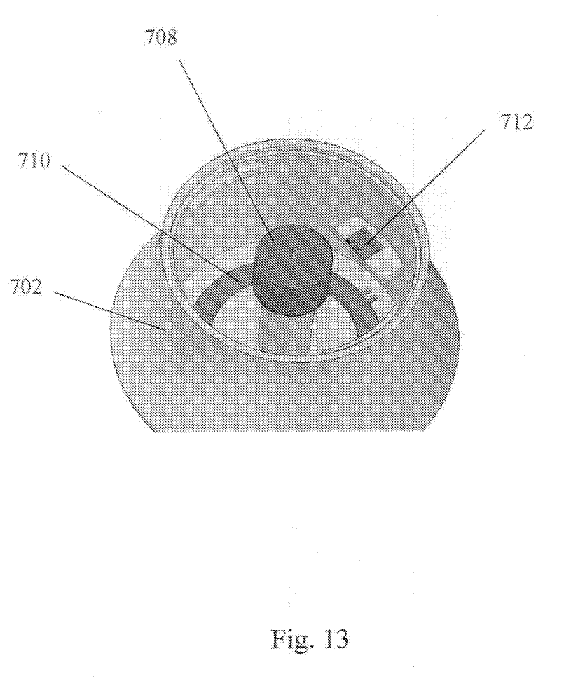

FIG. 13 depicts one embodiment of a base 702 of a beverage cup. In this embodiment, the base includes an actuator such as a motor 708 which may be coupled to a corresponding agitator 706 located in the receptacle. For instance, in some embodiments, the motor may be directly coupled to the agitator through the bottom of the receptacle. In such embodiments, a seal (not depicted) may be provided in the bottom of the receptacle to prevent leakage of beverage ingredients out of the receptacle. In other embodiments, the agitator may be indirectly coupled to the motor (e.g., magnetically coupled), and movement of the motor may cause corresponding movement of the agitator within the receptacle to mix the beverage ingredients.

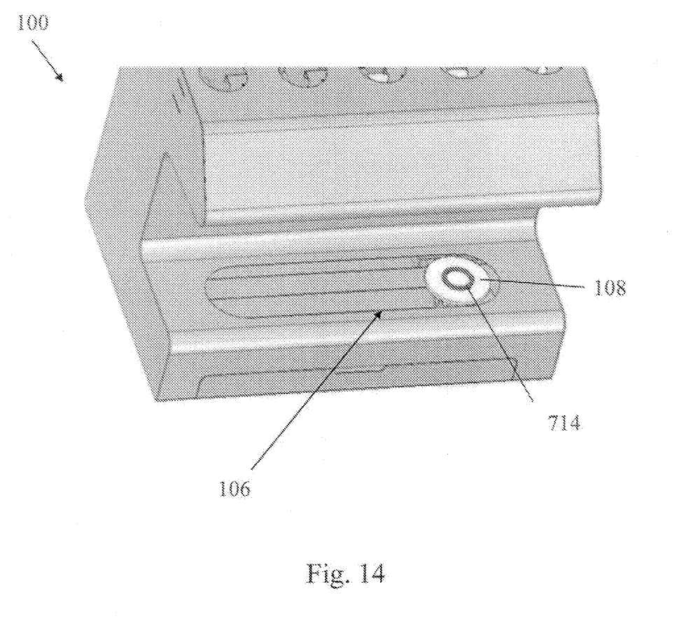

In some embodiments, an actuator of a beverage cup may be wirelessly coupled to a power source of a beverage system to power the actuator, for example via an inductive wireless power system. Accordingly, the base of a beverage cup may include a first coil 710 arranged to be wirelessly coupled to a corresponding second coil 714 located on a carriage 108 of a beverage system 100, as shown in FIG. 14. The second coil 714 may be electrically connected to a power source (not depicted) located within the beverage system, and the power source may be operated to produce an current within the second coil 714. This current may produce an magnetic field, which in turn may induce a current within the first coil 710 when the base 702 is received on the carriage 108. The induced current in the second coil may be used to power the actuator 708. Moreover, in some embodiments, a control circuit 712 may be included in the base to control aspects of the induced current and/or control the operation of the actuator. For example, in some instances, the induced current may be an alternating current, and the control circuit may include a rectifier to convert the alternating current to a direct current to drive the actuator. However, it should be understood that other arrangements for the control circuit 712 and actuator 708 may be suitable, as the current disclosure is not limited to any particular manner of controlling an actuator and an associated agitator to mix a beverage within a beverage cup.

As discussed previously, a beverage system may include one or more controllers to control various aspects of the operation of the beverage system. For example, as discussed above in connection with FIG. 3, a controller 150 may be arranged to control the function of one or more pumps and valves to control the flow of fluids (e.g., beverage ingredients) and gases within the system. Additionally, one or more controllers (such as controller 174 shown in FIG. 11) may be associated with a track and carriage to control movement of the carriage along the track, and/or a control circuit 712 may be arranged to control wireless power delivery to a mixing cup. In some embodiments, the various controllers may be part of a single system control circuit. For example, the various controllers may be communicate with one another via the system control circuit, and the system control circuit may coordinate the operation of the different control circuits to operate the beverage system and prepare a beverage. Thus, the system control circuit may include any suitable components to perform desired control, communication and/or other functions. For example, the system control circuit may include one or more general purpose computers, a network of computers, one or more microprocessors, etc. for performing data processing functions, one or more memories for storing data and/or operating instructions (e.g., including volatile and/or non-volatile memories such as optical disks and disk drives, semiconductor memory, magnetic tape or disk memories, and so on), communication buses or other communication devices for wired or wireless communication (e.g., including various wires, switches, connectors, Ethernet communication devices, WLAN communication devices, Bluetooth devices and so on), software or other computer-executable instructions (e.g., including instructions for carrying out functions related to controlling the various aspect the beverage system), a power supply or other power source (such as a plug for mating with an electrical outlet, batteries, transformers, etc.), relays and/or other switching devices, mechanical linkages, and/or one or more sensors or data input devices (such as flow sensors to detect an amount of a beverage ingredient dispensed and/or sensors to detect a position of the carriage along the track).

Moreover, a beverage system may include one or more user data input devices (such as buttons, dials, knobs, a keyboard, a touch screen or other), information display devices (such as an LCD display, indicator lights, etc.), and/or other components for providing desired input/output and control functions. In some embodiments, the input device and/or information display device may be a mobile device (such as a smart phone, a tablet, etc.) that communicates wirelessly to the system control circuit (e.g., via a Bluetooth and/or Wi-Fi protocol) such that a user may wirelessly control the operation of the beverage system.

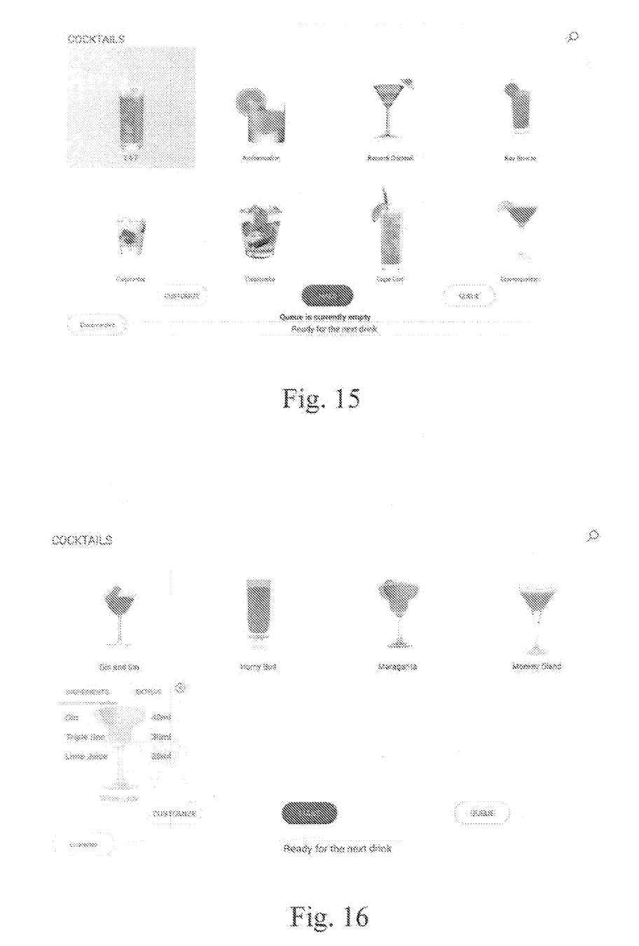

In some embodiments a user interface may include a mobile application configured to run on a mobile device to control the beverage system. For example, as shown in FIG. 15, the mobile application may present an array of possible beverages that may be prepared based on the beverage ingredients installed on the beverage system (e.g., via the container fittings 200 discussed above. In some embodiments, the mobile application may allow a user to search for a particular beverage based on the name of the beverage, and/or one or more beverage ingredients. For instance, a user may search for a particular type of alcoholic beverage ingredient, and the mobile application may display all of the beverages that the system may be able to prepare including that alcoholic beverage ingredient. A user may select a desired beverage from the user interface to request the beverage, and the mobile application may communicate the beverage request to an associated beverage system to prepare the beverage. For example, in some instances, the beverage request may be added to a queue, and the beverage system may prepare beverages according to the order of beverage requests in the queue. Moreover, the mobile application may be arranged to provide one or more notifications to the user to indicate the status of a beverage request, e.g., a notification that a beverage has been prepared.

As illustrated in FIG. 16, in some embodiments, a user interface may display information about a particular beverage when a user selects the beverage on the user interface. For example, such information may be beneficial if a user is not familiar with a particular beverage displayed on the user interface. The detailed information displayed when selecting the beverage may include the various ingredients that comprise the beverage, as well as the specific proportions of those ingredients. In this manner, the information displayed on the user interface may allow a user to select a desired beverage after learning of the ingredients of that beverage.

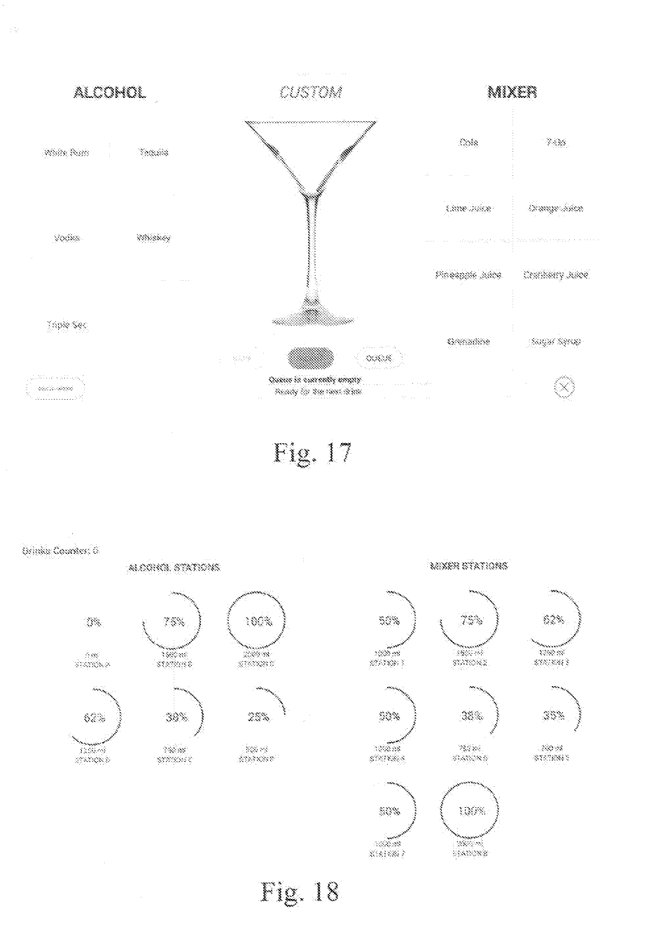

In some embodiments, it may be desirable to allow a user to customize a recipe for a particular beverage, and/or allow a user to define a custom beverage. Accordingly, in some embodiments, a user interface may permit customization of a beverage recipe (e.g., by allowing a user to vary the ingredients and/or proportions of ingredients in a recipe). In one embodiment depicted in FIG. 17, a user interface may display an interface to allow a user to define all of the beverage ingredients (e.g., alcoholic ingredients and/or non-alcoholic ingredients such as mixers) and the desired proportions of those ingredients. Further, the user interface may permit the user to save the customized beverage to allow the user to later request the same custom beverage.

In addition to allowing a user to select a desired beverage, in some embodiments, a user interface may include one or more elements for managing a beverage system. For example, as illustrated in FIG. 18, a user interface may be arranged to display a status of the beverage system, which may include the quantity of the various beverage ingredients remaining in respective beverage ingredient containers attached to the system. In particular, in the depicted embodiment, the user interface is arranged to display a percentage of beverage ingredients remaining for six alcoholic beverage ingredients and eight non-alcoholic beverage ingredients (e.g., non-carbonated and/or carbonated). Such information may be beneficial to indicate when a container of a particular beverage ingredient is nearing empty and needs to be changed. Moreover, in some embodiments, the user interface may include one or more interface elements to control a cleaning system, as discussed previously. For instance, the user interface may allow a user to select a desired cleaning interval such that the cleaning system is operated automatically after a predetermined amount of time and/or after a predetermined number of beverages have been prepared. Alternatively or additionally, a the user interface may allow a cleaning process to be initiated as needed.

In addition to the above, in certain embodiments, a beverage system may include one or more user interface elements located on the system. For example, as discussed previously, a beverage system may include om lighting elements (e.g., LED rings and/or strips), and the lighting elements may be selectively illuminated to indicate a status of the beverage system. In one embodiment, one or more lighting elements may be associated with a track and/or carriage, and the lighting elements may be selectively illuminated and/or change color depending on the status of a beverage preparation process. In other embodiments, one or more beverage ingredient containers may be illuminated (e.g., via lighting elements associated with container fittings), and the lighting elements may selectively illuminate a particular container as a beverage ingredient is being dispensed therefrom.

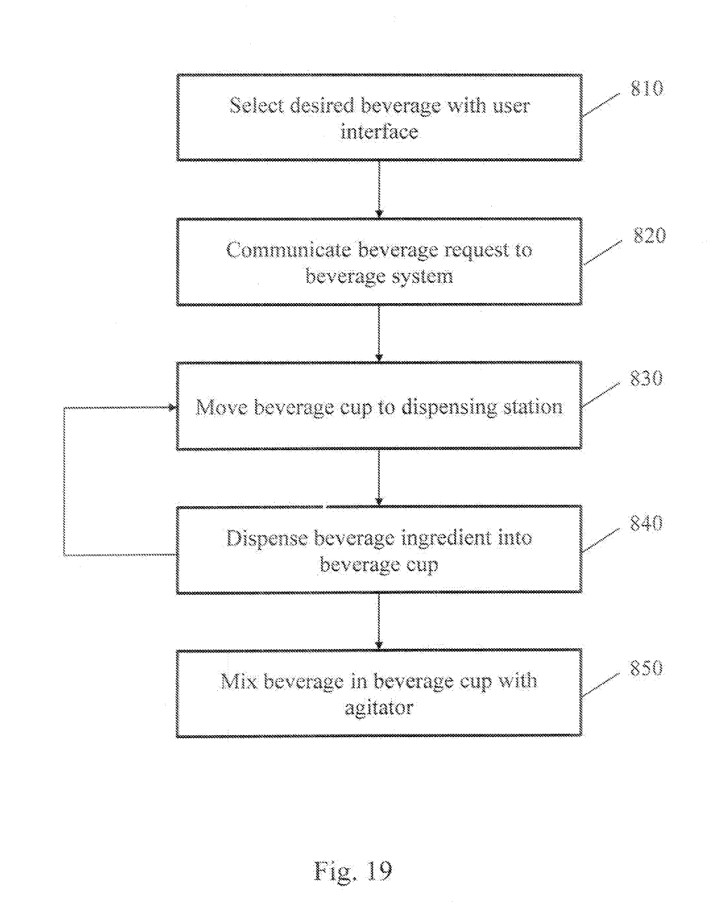

Having described various aspects of beverage systems, an exemplary method of operation of the beverage system is described in more detail in connection with FIG. 19. In particular, the method 800 includes first selecting a desired beverage with a user interface at step 810. As discussed previously, in some instances, selecting a desired beverage may include customizing a recipe for a particular beverage and/or defining a custom beverage via the user interface. At step 820, the beverage request is communicated from the user interface (e.g., from a mobile application running on a mobile device) to the beverage system, e.g., to a system controller on the beverage system. Based on the beverage request, the system controller may operate the beverage system to prepare the desired beverage. For example, at step 830, the controller may control an actuator (such as a stepper motor) to move a beverage cup to a dispensing station on the beverage system. Once the beverage cup is at the dispensing station, the controller may operate a distribution system (e.g., selectively operate one or more pumps and/or valves) at step 840 to cause a beverage ingredient to be dispensed into the beverage cup. For example, as discussed previously, the distribution system may pump air (or other gases) into a beverage ingredient container to cause outflow of the beverage ingredient from the beverage container, and the beverage ingredient may be directed to the dispensing station to be dispensed into the beverage cup. Moreover, as noted previously, it may be desirable to maintain a positive pressure within one or more beverage ingredient containers, and thus dispensing a beverage ingredient at step 840 may further include flowing air (or other gases) into a beverage ingredient container after a desired amount of the beverage ingredient has been dispensed. As illustrated in FIG. 19, steps 830 and 840 may be repeated to dispense multiple beverage ingredients as needed to fulfill a particular beverage request. Moreover, in some embodiments, multiple beverage ingredients may be dispensed at a single dispensing station. Once all of the beverage ingredients are dispensed into the beverage cup, the beverage ingredients may be mixed at step 850 to combine the beverage ingredients. For example, the beverage ingredients may be mixed with an agitator located within the beverage cup, and the system controller may operate the agitator, e.g., by selectively powering a wireless power coil in a carriage to power the agitator. However, as noted previously, preparing a beverage may not require mixing the beverage ingredients in some instances, as the desired beverage may be a non-homogenous mixture.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A beverage system comprising:
a housing; and
a container fitting located on the housing and constructed and arranged to mount a beverage ingredient container to the housing, wherein the container fitting includes a first channel to permit flow of a gas into the beverage ingredient container and a second channel to permit flow of a beverage ingredient out of the beverage ingredient container.

2. The beverage system of claim 1, wherein the container fitting is constructed and arranged to mount the beverage ingredient container in an inverted configuration on the housing.

3. The beverage system of claim 2, wherein the container fitting includes a support extending from a base plate and constructed and arranged to be received in an opening of the beverage ingredient container.

4. The beverage system of claim 3, wherein the first and second channels are formed in the support.

5. The beverage system of claim 3, further comprising one or more compliant seals constructed and arranged to engage the opening of the beverage ingredient container and seal the beverage ingredient container.

6. The beverage system of claim 5, wherein the one or more seals are provided around the post.

7. The beverage system of claim 4, wherein an opening of the first channel is spaced from an opening of the second channel.

8. The beverage system of claim 1, further comprising a valve coupled to the container fitting, wherein the valve selectively permits and prevents flow of the beverage ingredient through the first channel and flow of the gas through the second channel.

9. The beverage system of claim 8, further comprising a pump arranged to pump the gas into the beverage container.

10. The beverage system of claim 9, wherein, when the valve is in a first configuration in which the valve permits flow of the beverage ingredient through the first channel, flow of the gas into the beverage container through the second channel causes the beverage ingredient to flow out of the first channel.

11. The beverage system of claim 10, wherein, when the valve is in a second configuration in which the valve prevents flow of the beverage ingredient through the first channel, flow of the gas into the beverage container pressurizes the beverage container to a pressure greater than an ambient pressure.

12. A beverage system comprising:
a housing having a dispensing region including a plurality of dispensing stations;
a track located in the dispensing region; and
a carriage movable along the track between the plurality of dispensing stations;
an actuator drivingly coupled to the carriage to move the carriage along the track.

13. The beverage system of claim 12, further comprising a controller operatively associated with to the actuator to control movement of the carriage along the track.

14. The beverage system of claim 13, wherein the controller controls the actuator to provide a non-uniform acceleration profile for the carriage when moving the carriage between the plurality of dispensing stations.

15. The beverage system of claim 12, wherein the plurality of dispensing stations includes a first dispensing station to dispense alcoholic beverage ingredients and a second dispensing station to dispense non-alcoholic beverage ingredients.

16. The beverage system of claim 12, wherein the plurality of dispensing stations includes a first dispensing station to dispense alcoholic beverage ingredients, a second dispensing station to dispense non-alcoholic non-carbonated beverage ingredients, and a third beverage station to dispense non-alcoholic carbonated beverage ingredients.

17. The beverage system of claim 12, wherein each dispensing station of the plurality of dispensing stations is arranged to dispense a different beverage ingredient.

18. The beverage system of claim 12, wherein each dispensing station of the plurality of dispending stations is located at a different position along the track.

19. The beverage system of claim 12, wherein the carriage is constructed and arranged to receive a beverage cup and move the beverage cup between the plurality of dispensing stations.

20. The beverage system of claim 12, wherein the actuator includes a stepper motor.

21. The beverage system of claim 12, further comprising:
a beverage cup receivable in the dispensing region, the beverage cup comprising:
a base including a second actuator; and
a receptacle mounted on the base and including an agitator coupled to the second actuator, wherein the second actuator is constructed and arranged to move the agitator to mix one or more beverage ingredients received in the receptacle to form a beverage.

22. The beverage system of claim 21, wherein the carriage is constructed and arranged to couple to the base of the beverage cup to move the beverage cup between the dispensing stations.

23. The beverage system of claim 22, wherein the second actuator is wirelessly powered by a power transmitter located in the carriage.

24. The beverage system of claim 23, further comprising a first coil located in the carriage and coupled to a power supply, and a second coil located in the base, wherein the second coil is electrically connected to the second actuator and inductively coupled to the first coil.

25. The beverage system of claim 24, wherein the inductive coupling of the first and second coils transmits power from the power supply to the second actuator to wirelessly power the second actuator.

26. The beverage claim of 21, wherein the second actuator includes a motor constructed and arranged to rotate the agitator within the receptacle.

27-32. (canceled)
